(19) United States
(12) Patent Application Publication
(10) Pub. No.: US 2026/0048414 A1
(43) Pub. Date: Feb. 19, 2026

(54) METHOD FOR SURFACE-INITIATED POLYMERIZATION ON SURFACES AND COATED SUBTRATED FORMED THEREBY

(71) Applicant: ACULON, INC., SAN DIEGO, CA (US)

(72) Inventor: Eric L. Hanson, Carlsbad, CA (US)

(21) Appl. No.: 19/302,556

(22) Filed: Aug. 18, 2025

Related U.S. Application Data
(60) Provisional application No. 63/683,914, filed on Aug. 16, 2024.

(51) Int. Cl. B05D 5/08; B05D 1/00; B05D 3/02; B05D 3/06; B05D 3/14

(52) U.S. Cl. CPC B05D 5/08; B05D 1/60; B05D 3/0254; B05D 3/065; B05D 3/141; B05D 2201/02; B05D 2401/31

(57) ABSTRACT

Methods for applying a polymeric coating to a substrate are provided comprising:
(a) generating reactive functional groups on the polymeric substrate;
(b) contacting the substrate with a radical polymerization initiator;
(c) allowing the polymerization initiator to be chemically bonded to the substrate by reaction of the polymerization initiator with the reactive functional groups on the substrate;
(d) contacting the polymerization initiator that is chemically bonded to the substrate with a monomer composition comprising a free-radical polymerizable monomer having at least one hydrophilic functional group;
(e) forming a polymeric coating layer on the substrate via a radical polymerization process; and optionally
(f) subjecting the polymeric coating layer on the substrate to conditions to effect curing of reactive functional groups on the polymers of the polymeric coating layer. The monomer composition may comprise at least 10 percent by weight of a (meth)acrylamide monomer having at least one ionic functional group.

### RELATED APPLICATIONS

The present application claims the benefit of U.S. Provisional Patent Application Ser. No. 63/683,914, titled “Method for Surface-Initiated Polymerization on Surfaces”, filed Aug. 16, 2024, and incorporated by reference in its entirety.

The present application is related to International Patent Application Number PCT/US2022/049827, titled “COATED SUBSTRATES THAT DEMONSTRATE SUPERHYDROPHILICITY, SUITABLE FOR USE AS MEDICAL DEVICES”, filed Nov. 14, 2022, which in turn claims the benefit of U.S. Provisional Patent Application Ser. No. 63/281,016, titled “COATED SUBSTRATES THAT DEMONSTRATE SUPERHYDROPHILICITY, SUITABLE FOR USE AS MEDICAL DEVICES”, filed Nov. 18, 2021, and U.S. Provisional Patent Application Ser. No. 63/281,280, titled “COATED SUBSTRATES THAT DEMONSTRATE SUPERHYDROPHILICITY, SUITABLE FOR USE AS MEDICAL DEVICES”, filed Nov. 19, 2021, and incorporated by reference in their entireties.

### FIELD OF THE INVENTION

The present invention relates to methods for applying a polymeric coating to a surface.

### BACKGROUND OF THE INVENTION

Changing the surface energy of a substrate is of great value in many diverse industries and products, including medical devices; oil, gas and energy production; and electronics. Depending on the needs and applications, substrate surfaces can be customized to exhibit hydrophilic, hydrophobic, oleophobic and oleophilic properties. Exceptionally hydrophilic surfaces are particularly desired in certain high humidity environments to prevent fogging, and in aqueous environments to minimize surface air bubbles. For example, lenses used in vivo are particularly subject to fogging, distorting images. Rendering the surface hydrophilic is helpful in reducing fogging and other detriments.

Scientifically, liquids with lower surface tensions (e. g., oil with surface tensions <30 mN/m) tend to wet solid surfaces (with specific surface energy) more than liquids with higher surface tensions (e. g., water with surface tension of 72.8 mN/m). Coated surfaces may be prepared to yield different contact angles for liquids with higher surface tensions compared to those with lower surface tensions.

The modification of substrate surfaces with superhydrophilic coatings has been proposed; however, conventional coating processes typically generate films that are too thick for practical use in a medical device.

The modification of substrate surfaces with superhydrophilic polymers has also been proposed, using controlled radical polymerization (CRP) processes to dictate polymer architecture. Polymerization of (meth)acrylamide monomers that may provide such extreme hydrophilicity has historically been difficult to achieve via controlled radical polymerization processes such as ATRP, likely due to the exceptionally high rate of polymerization of these monomers as well as their chemical interaction with the copper-based catalysts typically used for such polymerization processes.

In addition, running these polymerizations in water adds another significant challenge due to the fact that ATRP initiators are usually activated alkyl halide compounds, which are highly prone to hydrolysis and rapidly lose their ability to control polymerization. When these polymerizations are conducted on surfaces in an aqueous medium, the ratio of initiating groups to water is many orders of magnitude in favor of water, making hydrolysis reactions far more likely than propagation of a polymer from an initiating site. Hence, the reported attempts of ATRP of (meth)acrylamide polymers in water are scarce, and surface-propagated polymerizations of them are absent from the literature to our knowledge.

Modifying the surfaces of substrates, including some modification methods that use CRP processes, tend to have drawbacks that make them unsuitable for many substrates because these processes typically employ solvents that are too aggressive, leading to degradation and/or swelling of a polymer substrate, or corrosion of a metal substrate caused by such solvents. For example, the most commonly used strategies for binding a polymerization initiator to a polymer surface use aggressive chemical attack to create functional groups (like hydroxyl, amine, etc.), followed by exposure to polar aprotic solvents such as diethyl ether, dichloromethane, etc., containing the initiator (for example, alpha-bromoisobutryl bromide) and a base catalyst such as triethylamine.

These methodologies are too aggressive to be used on most polymers, excepting highly fluorinated or crosslinked aromatic polymers such as PTFE, PFA, polyimide and PEEK. Commonly used polymers such as polyamide, pebax, acrylics, polyesters, polyolefins, PVC, and the like, are rapidly degraded by the aforementioned processes.

It would be desirable to provide methods for applying a polymeric coating demonstrating superhydrophilicity and anti-fouling to a surface.

### SUMMARY OF THE INVENTION

The present invention provides a method for applying a polymeric coating to a substrate comprising:
(a) forming an activated surface on the substrate by:
   (i) modifying the substrate via flame, corona discharge, argon plasma discharge or chemical etching to generate reactive functional groups on the substrate; or
   (ii) applying an activated layer comprising metal to the substrate to form reactive functional groups on the substrate;
(b) contacting the surface with a radical polymerization initiator such as by vapor deposition;
(c) allowing the polymerization initiator to be chemically bonded to the surface by reaction of the polymerization initiator with the reactive functional groups on the substrate;
(d) contacting the polymerization initiator that is chemically bonded to the surface with a monomer composition comprising a free-radical polymerizable monomer having at least one hydrophilic functional group, such as at least 10 percent by weight, based on the total weight of monomers in the monomer composition, of a (meth)acrylamide monomer having at least one ionic functional group;
(e) forming a polymeric coating layer on the surface via a controlled radical polymerization (CRP) process in an aqueous medium; and optionally
(f) subjecting the polymeric coating layer on the substrate to heat or UV radiation to effect curing of any reactive functional groups on the polymers of the polymeric coating layer.

These and other advantages of the present invention are described in the following detailed description of the invention.

### BRIEF DESCRIPTION OF THE DRAWINGS

FIG. 1 is a schematic view of a particular example of a substrate suitable for use in a method of the present invention. The substrate in this example comprises a polymeric film, wherein the film comprises two opposing surfaces, and wherein an adhesive is applied on one surface of the polymeric substrate as a backing.

FIG. 2 is a schematic molecular-scale view of a portion of a coated substrate prepared by a method of the present invention.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various aspects and examples of the present invention as presented herein are each understood to be non-limiting with respect to the scope of the invention.

As used in the following description and claims, the following terms have the meanings indicated below:

The terms “on”, “appended to”, “affixed to”, “bonded to”, “adhered to”, or terms of like import means that the designated item, e.g., a coating, film or layer, is either directly connected to (in contact with) the object surface, or indirectly connected to the object surface, e.g., through one or more other coatings, films or layers.

The coated articles and medical devices 10 formed by the methods of the present disclosure comprise (a) a substrate 12 with a surface having reactive functional groups. Substrates 12 suitable for use in the preparation of the coated articles and medical devices can include a silicate such as glass, including fiberglass; ceramic; a metal selected from at least one of aluminum, copper, stainless steel, a metal oxide, nitinol, palladium, nickel, tantalum and titanium; or a polymer selected from at least one of a polyamide, a polyamide-polyether block copolymer, a poly(meth)acrylate, a polyester, a polyolefin, a polyisoprene, a polyurethane, a polyester-polyurethane copolymer, a polyimide, a cycloolefin polymer, a polyether ketone, a polysulfone, a polycarbonate and a polysiloxane.

The substrates 12 may be porous or nonporous. Porous substrates 12 may be inherently porous or may be perforated with ordered or random microarrays of microchannels. “Microchannels” are understood to be micro-dimensional fluidic channels (e. g., having average diameters on a micron or nanometer scale). In microtechnology, a microchannel is understood to have a hydraulic diameter below 1 millimeter, such as below 500 microns, or below 100 microns, or below 1 micron.

The substrate 12 has reactive functional groups on the surface. Suitable functional groups include active hydrogen groups such as hydroxyl, amido, thiol, carboxylic acid, epoxy, amine functional groups, and the like. The reactive functional groups allow for chemical bonding between the substrate 12 and a polymerization initiator 14, as shown in FIG. 2.

The substrate 12 may take any shape as desired for the intended application, such as flat, curved, bowl-shaped, tubular, or flexible freeform, depending on the final product. For example, the substrate 12 may be in the form of a flat plate or a lens having two opposing surfaces. The thickness of the substrate 12 likewise depends on the nature of the final product. The coating 16 may be applied to one or all of the surfaces of the substrate 12, such as both of two opposing surfaces.

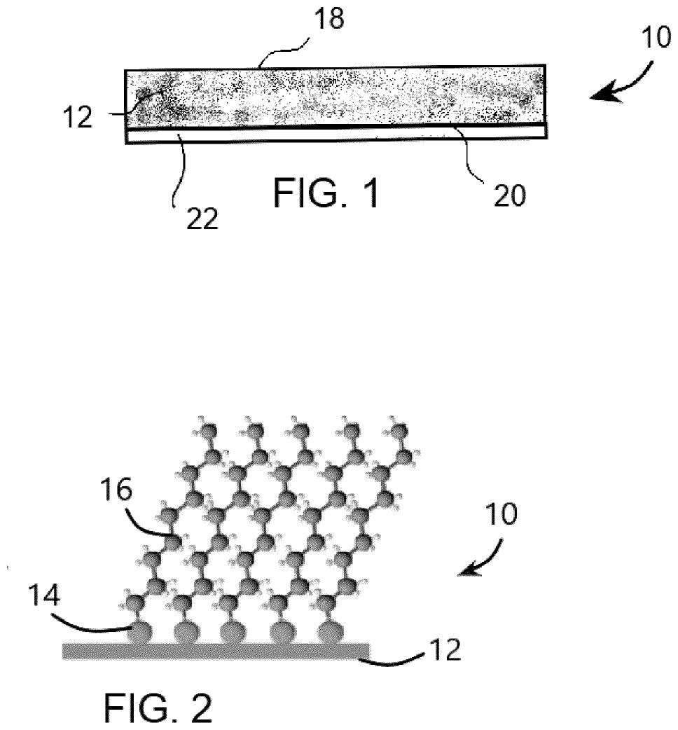

In a particular example shown in FIG. 1, the substrate 12 comprises a polymeric (e. g., polyethylene, polypropylene, or polyamide such as nylon) film. The film comprises two opposing surfaces 18 and 20, wherein an adhesive layer 22 such as a pressure sensitive adhesive is applied on one surface 20 of the polymeric substrate 12 as a backing, allowing for preparation of the opposing surface 18 with the initiator and polymeric coating layer to form a coated substrate 12. The coated substrate 12 may then be applied via the adhesive layer 22 to any suitable article, including a prefabricated article. Such a coated substrate 12 with an adhesive backing allows for applying the coated film 10 to any manufactured article onsite in the field or factory during any manufacturing or other industrial process.

The substrate 12 may comprise any of a number of different medical devices, industrial articles or components of articles, including medical diagnostic equipment, a needle, a syringe, a tube or pumping system used for biological media, a lens, an intraocular lens, an intraocular lens delivery system, a catheter, a breathing apparatus, an electronic device, an implantable device for humans, an electronic fluidic device, a sensor, a mold, a biological/DNA assay surface, filter media, a fluidic microchannel, a heat exchanger, oil spill remediation equipment or oil processing equipment.

Before bonding the polymerization initiator 14 to the substrate 12, an activated surface is formed on the substrate 12. The surface of the substrate 12 may be modified by any of a variety of well-known techniques such as flame, corona or argon plasma discharge, or chemical etching (particularly using a NaOH or KOH solution), to generate the reactive functional groups, such as hydroxyl, amido, thiol, carboxylic acid, epoxy and/or amine functional groups on the substrate surface.

Alternatively, an activated layer comprising metal may be applied to the substrate to form the reactive functional groups on the substrate. When this method is used, the activated layer may comprise one or more of Ti, Cr, Al, Ta, Nb, Ni, silver oxide, gold oxide, palladium oxide, platinum oxide, rhodium oxide, iridium oxide, tantalum oxide, aluminum oxide, copper oxide, titanium oxide, iron oxide, zirconium oxide, silicon oxide and chromium oxide.

The coated articles 10 and medical devices 10 further comprise (b) a polymerization initiator 14 chemically bonded to the substrate 12 via reaction with the reactive functional groups on the surface of the substrate 12. The polymerization initiator 14 may be bonded to the substrate using conventional techniques, including solution-based application, physical vapor deposition (PVD) or chemical vapor deposition (CVD), to ensure a thin layer of molecular dimensions. The reaction of the polymerization initiator 14 with the reactive functional groups on the surface of the substrate 12 is most often a vapor phase reaction.

Any initiators known in the art for radical polymerization processes, in particular, living (i. e., controlled radical) polymerization processes are suitable, provided they may be chemically bonded to the substrate surface by reaction with the reactive functional groups. Organosilicon compounds may serve as an initiator. Suitable organosilicon compounds include alkoxysilane functional compounds such as (3-trimethoxysilyl)propyl-2-bromo-2-methylpropionate. Also suitable are organosilicon-containing compounds with ethylenically unsaturated groups, such as (3-trimethoxysilyl)propyl (meth)acrylate, and (3-trimethoxysilyl)propyl (meth)acrylamide. Also useful are organophosphorus acids chemically bonded to the substrate surface, wherein the organo portion of the organophosphorus acid contains an initiator moiety such as a halide group (e. g., bromide, chloride, or iodide). Other halogen-containing compounds including benzyl halides, 2-halo-propionitriles, alkyl or acyl halide compounds, such as isobutyryl halides, α-halooisobutyryl halide (e. g. α-bromoisobutyryl bromide), are also suitable. Azo-initiators such as azobisbutyronitrile (AIBN 1,1′-azobis(cyclohexanecarbonitrile); and 4,4-azobis (4-cyanopentanoic acid), and K₂S₂O₈, as used in addition-fragmentation chain transfer (RAFT) polymerization processes may also be employed.

The coated articles and medical devices further comprise (c) a polymeric coating layer 16. The polymeric coating layer 16 is chemically bonded to and propagated from the polymerization initiator 14.

The polymeric coating layer 16 may be prepared from a monomer composition, which is usually aqueous, comprising at least one free radical polymerizable monomer having at least one hydrophilic functional group. Any monomer capable of free-radical polymerization may be used in the aqueous monomer composition. Examples of particularly suitable monomers include hydrophilic styrene functional monomers, acrylonitrile, (meth)acrylamide functional monomers, 4-vinylpyridine, sodium 4-vinylbenzenesulfonate, and monomers that are quaternized with a halide (e. g., chloride or fluoride) or have functional groups that are capable of being quaternized with a halide after polymerization. Other suitable monomers include dienes, alkylvinyl monomers or allyl ethers.

In a particular example, the polymeric coating layer is prepared from an aqueous monomer composition comprising at least 10 percent by weight, such as at least 50 percent by weight, based on the total weight of monomers in the monomer composition, of at least one (meth)acrylamide monomer having at least one ionic functional group. For example, the polymeric coating layer 16 may be formed from an aqueous monomer composition comprising at least one of a (meth)acrylamide halide salt, 2-aminoethylmethacrylamide hydrochloride halide salt, N,N′-(3-(dimethylamino)propyl) methacrylamide, N,N-(3-dimethylamino)propyl)-methacryloylaminobutyl sulfonate, N,N-(3-dimethylamino)propyl)-methacryloylaminopropyl sulfonate, 2-acrylamidopropane-2-methyl-1-propane sulfonic acid salt, [3-(methacryloylamino)propyl]trimethylammonium chloride, [3-(acryloylamino)propyl]trimethylammonium chloride, N,N′-dimethyl(meth)acrylamide and salts thereof, and 3-[(3-(meth)acrylamidopropyl)dimethylammonio]propanoate. The polymeric coating layer 16 may comprise a homopolymer of any of the above monomers, or may comprise a copolymer, such as a block copolymer, of two or more of the above monomers.

The polymeric coating layer 16 is typically prepared via a controlled radical polymerization (CRP) or “living” process; i. e., a chain-growth polymerization that propagates with essentially no chain transfer and essentially no chain termination. The molecular weight of a polymer prepared by CRP can be controlled by the stoichiometry of the reactants, i.e., the initial concentration of monomer(s) and initiator(s). In addition, CRP also provides polymers having characteristics including, for example, narrow molecular weight distributions, e. g., PDI values less than 2.5, and well-defined polymer chain architecture, e. g., block copolymers and alternating copolymers. As used herein, the term “controlled radical polymerization” and related terms such as “controlled radical polymerization process” includes, but is not limited to, atom transfer radical polymerization (ATRP), single electron transfer polymerization (SETP), reversible addition-fragmentation chain transfer (RAFT), and nitroxide-mediated polymerization (NMP).

In forming the coated articles 10 using the method of the present invention, the surface of the substrate 12 is first contacted with initiator molecules to bond the initiator to the substrate 12. The initiator-coated substrate is then contacted with the monomer composition described above and a CRP catalyst, and polymerized under CRP conditions in an aqueous medium to form a layer or film of (meth)acrylamide-containing polymer 16.

In an example using ATRP, the substrate 12 surface having reactive functional groups is contacted with a compound containing in a terminal portion a functional group reactive with the reactive functional groups on the substrate 12 surface, and in a second terminal portion, an initiator for ATRP. A self-assembled monolayer (SAM) is formed from the compound bonded to the substrate 12 surface, with the initiator extending outwardly from the substrate 12 surface. The SAM is contacted with an aqueous mixture comprising the monomer composition and an ATRP catalyst, and the monomer composition is polymerized to form a layer of (meth)acrylamide-containing polymer on the substrate 12 surface, chemically bonded to and propagated from the polymerization initiator.

The ATRP polymerization catalyst is typically a transition metal compound, which participates in a reversible redox cycle with the initiator; and a ligand, which coordinates with the transition metal compound. The ATRP process is described in further detail in International Patent Publication No. WO 98/40415 and U.S. Pat. Nos. 5,807,937, 5,763,548 and 5,789,487 which are incorporated herein by reference.

Catalysts that may be used in the ATRP preparation include any transition metal compound. It is preferred that the transition metal compound not form direct carbon-metal bonds with the polymer chain. Transition metal catalysts useful in the present invention may be represented by the following general formula:

Mⁿ⁺Xₙ

wherein M is the transition metal, n is the formal charge on the transition metal having a value of from 0 to 7, and X is a counterion or covalently bonded component. Examples of the transition metal M include, but are not limited to, Cu, Fe, Au, Ag, Hg, Pd, Pt, Co, Mn, Ru, Mo, Nb and Zn. Examples of X include, but are not limited to, halide, hydroxy, oxygen, C₁-C₆ alkoxy, cyano, cyanato, thiocyanato and azido. A preferred transition metal is Cu(I) and X is preferably halide, e.g., chloride. Accordingly, a preferred class of transition metal catalyst is the copper halides, e.g., Cu(I)Cl. It is also preferred that the transition metal catalyst contain a small amount, e.g., 1 mole percent, of a redox conjugate, for example, Cu(II)Cl₂, when Cu(I)Cl is used. Additional catalyst useful in preparing the pigment dispersant are described in U.S. Pat. No. 5,807,937 at column 18, lines 29 through 56 which patent is incorporated herein by reference in its entirety. Redox conjugates are described in further detail in U.S. Pat. No. 5,807,937 at column 11, line 1 through column 13, line 38 which patent is incorporated herein by reference in its entirety.

Ligands that may be used in ATRP for preparation of the polymerization catalyst include compounds having one or more nitrogen, oxygen, phosphorus and/or sulfur atoms, which can coordinate to the transition metal catalyst compound, e. g., through sigma and/or pi bonds. Classes of useful ligands include tertiary aliphatic amines, unsubstituted and substituted pyridines and bipyridines; porphyrins; cryptands; crown ethers; e.g., 18-crown-6; polyamines, e.g., ethylenediamine; glycols, e.g., alkylene glycols, such as ethylene glycol; carbon monoxide; and coordinating monomers, e.g., styrene, acrylonitrile and hydroxyalkyl(meth)acrylates. Note that the phrase “and/or” when used in a list is meant to encompass alternative embodiments including each individual component in the list as well as any combination of components. For example, the list “A, B, and/or C” is meant to encompass seven separate embodiments that include A, or B, or C, or A+B, or A+C, or B+C, or A+B+C.

As used herein and in the claims, the term “(meth)acrylate” and similar terms refer to acrylates, methacrylates and mixtures of acrylates and methacrylates; similarly for (meth)acrylamide. A preferred class of ligands are the substituted bipyridines, e.g., 4,4′-dialkyl-bipyridyls. Additional ligands that may be used in preparing pigment dispersant are described in U.S. Pat. No. 5,807,937 at column 18, line 57 through column 21, line 43 which patent is incorporated herein by reference in its entirety.

A reducing agent is often included in the aqueous monomer composition to enhance polymerization efficiency. The reducing agent may be any reducing agent capable of reducing the transition metal catalyst from a higher oxidation state to a lower oxidation state, thereby reforming the catalyst activator state. Such reducing agents include, for example, SO₂, sulfites, bisulfites, thiosulfites, mercaptans, hydroxylamines, hydrazine (N₂H₄), phenylhydrazine (Ph-NHNH₂), hydrazones, hydroquinone, food preservatives, flavonoids, beta carotene, vitamin A, α-tocopherols, vitamin E, propyl gallate, octyl gallate, BHA, BHT, propionic acids, ascorbic acid, sorbates, reducing sugars, sugars comprising an aldehyde group glucose, lactose, fructose, dextrose, potassium tartrate, nitriles, nitrites, dextrin, aldehydes, glycine, and transition metal salts. Water-soluble reducing agents are particularly suitable.

The above-mentioned ingredients are dissolved or suspended in an aqueous medium which may include in minor portions a diluent such as an organic solvent, for example, acetone or methanol. Also, solvents such as those containing oligo ethylene oxide and propylene oxide groups, such as diethylene glycol, diethylene glycol monomethyl ether and tripropylene glycol monomethyl ether may be used in minor portions. Such solvents may boost the activity of the catalyst. The concentration of the radically polymerizable monomers is typically from 5 to 70 percent by weight based on total weight of solution. The molar ratio of catalyst to monomer ranges from 1:5 to 1:500, such as 1:20 to 1:100; the molar ratio of ligand to catalyst ranges from 1:2 to 1:100, such as 1:2 to 1:5. The molar ratio of reducing agent to catalyst is from 1:0.1 to 10 such as 1:0.5 to 2.

The solution of the radically polymerizable monomer composition can be applied to the initiator-coated substrate 12 by conventional means such as dipping, rolling, spraying, printing, stamping or wiping to ensure uniform coating of the substrate surface. The formation of the ATRP film or coating can occur at temperatures in the range of −10 to 150° C. and at pressures of 1-100 atmospheres, usually at ambient temperature and pressure. By “ambient” conditions is meant without the application of heat or other energy; for example, when a curable composition undergoes a thermosetting reaction without baking in an oven, use of forced air, irradiation, or the like to prompt the reaction, the reaction is said to occur under ambient conditions. Usually, ambient temperature ranges from 60 to 90° F. (15.6 to 32.2° C.), such as a typical room temperature, 72° F. (22.2° C.). The time for conducting the ATRP can vary depending on the thickness of the film desired. The polymeric coating layer (c) typically has a thickness greater than 50 nm and less than 2.5 microns, such as less than 2 microns, or less than 1 micron, or even less than 100 nm. Such thick coating layers of aqueous CRP-generated (meth)acrylamide polymer coating layers have not been achieved previously; the thickness of the coating contributes to lubricity. The thickness of the film can be monitored by Quartz Crystal Microgravometric (QCM) measurement and the time for the ATRP is typically from 30 to 600 minutes. After ATRP, the coated substrate is removed from any remaining solution by rinsing with a polar solvent and drying the coated substrate.

When the surface of the initiator-coated substrate 12 is exposed to the aqueous solution of the radically polymerizable monomer composition and subjected to ATRP conditions, the monomers contained therein form covalent bonds with each other and with the initiator groups that are bonded to the surface of the substrate. As mentioned above, the resultant coating or film (i. e., the polymeric layer 16) is relatively thick (compared to typical surface ATRP processes) with strong adhesion to the substrate 12. The resulting polymer forming coating layer 16 has a low polydispersity index because chain transfer reactions are minimized. Lower polydispersity indices enable the molecular weight of the polymer to be controlled and optimized for the particular application intended.

The process may further include subjecting the polymeric coating layer 16 on the coated substrate 12 to heat or UV radiation to effect curing of any reactive functional groups on the polymers of the polymeric coating layer 16. Such curing may further ensure a robust and durable polymeric coating layer 16.

The term “cure”, “cured” or similar terms, as used in connection with a cured or curable composition, e.g., a “cured composition” of some specific description, means that at least a portion of any polymerizable and/or crosslinkable components that form the curable composition is polymerized and/or crosslinked. Additionally, curing of a composition refers to subjecting said composition to curing conditions such as heating or exposure to actinic radiation, depending on the chemistry, leading to the reaction of any reactive functional groups in the composition. The term “at least partially cured” means subjecting the composition to curing conditions, wherein reaction of at least a portion of the reactive groups of the composition occurs. The composition can be subjected to curing conditions as necessary depending on the composition of the coating layers, such that a substantially complete cure is attained and wherein further curing results in no significant further improvement in physical properties, such as hardness.

The resultant coated articles 10 are hydrophilic, even superhydrophilic, demonstrating lubricity making them useful for easy clean coatings, antifog coatings and mold release agents. The coating layer typically demonstrates a water contact angle less than 10°, often less than 5°, and retains a contact angle of less than 10° after immersion in phosphate buffered (approximate pH of 7.4) aqueous saline solution at 22° C. for a period of 28 days, often greater than 28 days. Additionally, the coating layer will not lose its hydrophilic or lubricious properties under these conditions.

By “superhydrophilicity” is meant a high degree of hydrophilicity, or attraction to water; in superhydrophilic materials, the contact angle of water is less than 10°, often less than 5° even equal to 0°. The coatings are also antifouling and can be useful in applications such as coatings for ship hulls, implanted biomaterials, medical instruments and drug delivery apparatus. In some cases, the coated surface prevents adsorption of proteinaceous compounds (DNA, serum proteins, etc.)

Whereas particular embodiments of this invention have been described above for purposes of illustration, it will be evident to those skilled in the art that numerous variations of the details of the present invention may be made without departing from the scope of the invention as defined in the appended claims.

What is claimed is:

1. A method for applying a polymeric coating to a substrate comprising:
(a) forming an activated surface on the substrate by:
(i) modifying the substrate via flame, corona discharge, argon plasma discharge or chemical etching to generate reactive functional groups on the substrate; or
(ii) applying an activated layer comprising metal to the substrate to form reactive functional groups on the substrate;
(b) contacting the substrate with a radical polymerization initiator;
(c) allowing the polymerization initiator to be chemically bonded to the substrate by reaction of the polymerization initiator with the reactive functional groups on the substrate;
(d) contacting the polymerization initiator that is chemically bonded to the substrate with a monomer composition comprising a free-radical polymerizable monomer having at least one hydrophilic functional group;
(e) forming a polymeric coating layer on the substrate via a radical polymerization process; and optionally
(f) subjecting the polymeric coating layer on the substrate to heat or UV radiation to effect curing of any reactive functional groups on the polymers of the polymeric coating layer.

2. The method of claim 1, wherein the substrate comprises medical diagnostic equipment, a needle, a syringe, a tube or pumping system used for biological media, a lens, an intraocular lens, an intraocular lens delivery system, a catheter, a breathing apparatus, an electronic device, an implantable device for humans, an electronic fluidic device, a sensor, a mold, or a biological/DNA assay surface, and is formed from at least one of a metal, a silicate, ceramic, a polyamide, a polyamide-polyether block copolymer, a poly(meth)acrylate, a polyester, a polyolefin, a polyisoprene, a polyurethane, a polyester-polyurethane copolymer, a polyimide, a cycloolefin polymer, a polyether ketone, a polysulfone, a polycarbonate and a polysiloxane.

3. The method of claim 1, wherein the substrate is modified via argon plasma discharge to generate the reactive functional groups on the substrate.

4. The method of claim 1, wherein the activated surface is formed by applying the activated layer comprising metal to the substrate, and wherein the activated layer comprises one or more of Ti, Cr, Al, Ta, Nb, Ni, silver oxide, gold oxide, palladium oxide, platinum oxide, rhodium oxide, iridium oxide, tantalum oxide, aluminum oxide, copper oxide, titanium oxide, iron oxide, zirconium oxide, silicon oxide and chromium oxide.

5. The method of claim 1 wherein the reactive functional groups comprise hydroxyl, amido, thiol, carboxylic acid, epoxy and/or amine functional groups.

6. The method of claim 1, wherein the substrate is contacted with the radical polymerization initiator via physical or chemical vapor deposition.

7. The method of claim 1, wherein the polymerization initiator comprises a halogen-containing compound.

8. The method of claim 1, wherein the polymerization initiator comprises an isobutyryl halide, a benzyl halide, a 2-halo-propionitrile, an α-haloisobutyryl halide, azobisbutyronitrile (AIBN), 1,1′-azobis(cyclohexanecarbonitrile), 4,4-azobis (4-cyanopentanoic acid), or potassium persulfate (K₂S₂O₈).

9. The method of claim 1, wherein the monomer composition comprises at least one of a styrene functional monomer, acrylonitrile, (meth)acrylamide functional monomer, 4-vinylpyridine, sodium 4-vinylbenzenesulfonate, a monomer that is quaternized with a halide or has functional groups that are capable of being quaternized with a halide after polymerization, 2-aminoethylmethacrylamide hydrochloride halide salt, N,N′-(3-(dimethylamino)propyl) methacrylamide, N,N-(3-dimethylamino)propyl)-methacryloylaminobutyl sulfonate, N,N-(3-dimethylamino)propyl)-methacryloylaminopropyl sulfonate, 2-acrylamidopropane-2-methyl-1-propane sulfonic acid salt, [3-(methacryloylamino)propyl]trimethylammonium chloride, [3-(acryloylamino)propyl]trimethylammonium chloride, N,N′-dimethyl(meth)acrylamide and salts thereof, and 3-[(3-(meth)acrylamidopropyl)dimethylammonio]propanoate.

10. The method of claim 1, wherein the monomer composition further comprises a polymerization catalyst.

11. The method of claim 10, wherein the polymerization catalyst comprises a transition metal catalyst and the monomer composition further comprises a reducing agent.

12. The method of claim 1 wherein the radical polymerization process is an ATRP process.

13. The method of claim 1, wherein the monomer composition is contacted with the polymerization initiator by dipping, rolling, spraying, printing, stamping or wiping.

14. The method of claim 1, wherein the polymeric coating layer comprises a block copolymer.

15. The method of claim 1, wherein the polymeric coating layer demonstrates a water contact angle less than 10° and retains a contact angle of less than 10° after immersion in phosphate buffered aqueous saline solution at 22° C. for a period of 28 days.

16. A method for applying a polymeric coating to a substrate comprising:
(a) forming an activated surface on the substrate by:
(i) modifying the substrate via flame, corona discharge, argon plasma discharge or chemical etching to generate reactive functional groups on the substrate; or
(ii) applying an activated layer comprising metal to the substrate to form reactive functional groups on the substrate;
(b) contacting the substrate with a radical polymerization initiator via vapor deposition;
(c) allowing the polymerization initiator to be chemically bonded to the substrate by reaction of the polymerization initiator with the reactive functional groups on the substrate;
(d) contacting the polymerization initiator that is chemically bonded to the substrate with an aqueous monomer composition comprising at least 10 percent by weight, based on the total weight of monomers in the monomer composition, of a (meth)acrylamide monomer having at least one ionic functional group;
(e) forming a polymeric coating layer on the substrate via a controlled radical polymerization (CRP) process in an aqueous medium; and optionally
(f) subjecting the polymeric coating layer on the substrate to heat or UV radiation to effect curing of any reactive functional groups on the polymers of the polymeric coating layer.

17. The method of claim 16, wherein the substrate comprises at least one of a polyamide, a polyamide-polyether block copolymer, a poly(meth)acrylate, a polyester, a polyolefin, a polyisoprene, a polyurethane, a polyester-polyurethane copolymer, a polyimide, a cycloolefin polymer, a polyether ketone, a polysulfone, a polycarbonate and a polysiloxane.

18. The method of claim 16 wherein the substrate is modified via argon plasma discharge and wherein the reactive functional groups comprise hydroxyl, amido, thiol, carboxylic acid, epoxy and/or amine functional groups, or wherein the CRP process is an ATRP process.

19. The method of claim 16, wherein the polymerization initiator comprises an isobutyryl halide, a benzyl halide, a 2-halo-propionitrile, an α-haloisobutyryl halide, azobisbutyronitrile (AIBN), 1,1′-azobis(cyclohexanecarbonitrile), 4,4-azobis (4-cyanopentanoic acid), or potassium persulfate (K₂S₂O₈).

20. The method of claim 16, wherein the aqueous monomer composition comprises at least one of a styrene functional monomer, acrylonitrile, (meth)acrylamide functional monomer, 4-vinylpyridine, sodium 4-vinylbenzenesulfonate, a monomer that is quaternized with a halide or has functional groups that are capable of being quaternized with a halide after polymerization, 2-aminoethylmethacrylamide hydrochloride halide salt, N,N′-(3-(dimethylamino)propyl) methacrylamide, N,N-(3-dimethylamino)propyl)-methacryloylaminobutyl sulfonate, N,N-(3-dimethylamino)propyl)-methacryloylaminopropyl sulfonate, 2-acrylamidopropane-2-methyl-1-propane sulfonic acid salt, [3-(methacryloylamino)propyl]trimethylammonium chloride, [3-(acryloylamino)propyl]trimethylammonium chloride, N,N′-dimethyl(meth)acrylamide and salts thereof, and 3-[(3-(meth)acrylamidopropyl)dimethylammonio]propanoate.
